(19) United States
(12) Patent Application Publication
(10) Pub. No.: US 2008/0063819 A1
(43) Pub. Date: Mar. 13, 2008

(54) INSULATED BULLET RESISTANT GLASS

(75) Inventors: Clifford J. Monroe, Columbia, TN (US); Craig B. Duncan, Trinity, FL (US)

Correspondence Address: SCHNADER HARRISON SEGAL & LEWIS, LLP, 1600 MARKET STREET, SUITE 3600, PHILADELPHIA, PA, 19103, US

(73) Assignee: ARCH ALUMINUM & GLASS COMPANY, INC., TAMARAC, FL (US)

(21) Appl. No.: 11/530,683

(22) Filed: Sep. 11, 2006

(51) Int. Cl. B32B 27/32; B32B 17/10; B32B 17/06

(52) U.S. Cl. 428/34; 428/426; 428/220; 428/332; 428/430

(57) ABSTRACT

An insulated bullet resistant glass structure is disclosed. An interior glass component has a glass sheet with a film applied to at least one side. An exterior glass component has a glass sheet with a film applied to at least one side. An insulating space is present between the interior glass component and the exterior glass component. Impact resistant films are applied to faces of the interior and exterior glass components

### BACKGROUND OF THE INVENTION

Bullet resistant glass according to conventional technology generally includes laminated glass, which consists of two or more glass panes of various thicknesses bonded together. Such glass typically has a thickness of about 3 inches or greater and weighs in excess of 14.0 lbs/ft². The weight and size of the present glass structures renders them costly to manufacture, handle and transport. Additionally, the glass structures can be cumbersome to work with in large sizes and are not compatible with standard glass frame designs. Furthermore, to the inventor's knowledge, bullet resistant glass currently on the market does not offer particularly good insulating properties.

Current window technology includes laminated glass systems that combine glass with a strong, transparent vinyl or liquid pored interlayer to provide building owners and occupants with increased security and safety from shattering glass due to weather or crime. Laminated glass window systems having such interlayers reduce the potential for broken glass being blown from its frames, which is the leading cause of injuries in turbulent conditions. Although such systems provide some safety, they cannot withstand the force of high impact projectiles, and are not considered bullet resistant.

Accordingly, there is a need for a lightweight bullet resistant apparatus that provides sufficient resistance to impact by bullets and other projectiles, provides reasonably good insulation and offers versatility with multiple glass substrate selections and combinations for energy efficiency.

### SUMMARY OF THE INVENTION

Embodiments of the present invention provide an insulated bullet resistant glass structure that can be created in a light weight configuration. The structure includes at least two glass panes with an insulating space therebetween. Impact resistant films are applied to the surfaces of the glass panes facing the insulated space and to the surface of the glass pane facing the space to be protected by the structure.

### DESCRIPTION OF THE DRAWINGS

The invention is best understood from the following detailed description when read with the accompanying drawings.

FIG. 1 depicts a bullet resistant apparatus according to an illustrative embodiment of the invention.

FIG. 2 depicts a frame for a bullet resistant apparatus according to an illustrative embodiment of the invention.

FIG. 3 depicts a frame for a bullet resistant apparatus according to a further illustrative embodiment of the invention.

### DETAILED DESCRIPTION OF THE INVENTION

Embodiments of the present invention provide an insulated, bullet resistant glass apparatus that can be manufactured as a relatively light weight structure. The thickness of the structure can also be made to fit within traditional standardized glazing systems. To the inventor's knowledge, there is not a bullet resistant insulated glass unit in the prior art. Additionally, there are no bullet resistant units on the market using applied films as the barrier to the bullet penetration.

Applied films are materials that are applied to glass with a roller device with the film having some sort of adhesive to bond it to the glass. The film can, as in this case, help prevent a projectile from migrating through the glass or film. Film can be applied to a piece of glass as a finished product and can be applied to any surface of the glass. This differs from laminated glass, which has an interlayer between the pieces of glass that serves as a bonding agent between the two pieces of glass. The interlayer is typically a thermoplastic polymer.

It is noted in addition to the bullet resistant applied film, which is most preferably applied to the interior surface of the glass, other applied films may be used in the assembly, such as those that provide scratch resistance. Scratch resistant films would most preferably be applied to the exterior surface.

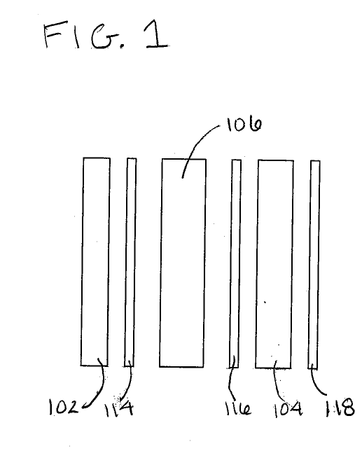

FIG. 1 provides a cross-sectional view of a bullet resistant glass construction according to an illustrative embodiment of invention. In this embodiment, the apparatus includes two glass sections 102, 104. The first glass section 102 is exposed to the exterior of a building or other protected space. The second glass section 104 faces the interior of the protected space. Between glass sections 102, 104 is an insulating space 106. Films 114, 116, 118 are applied to the glass sections to provide projectile resistance. In a particular embodiment, both the first and second glass sections 102, 104 have a film 114, 116, respectively, applied to the surfaces facing the insulating space. In addition, the second glass section 104 has a film 118 applied to the surface facing the interior of the protected space.

Other combinations of components are within the spirit and scope of the invention, such as having a laminate on one side of the insulating space and glass with an applied film on the other side.

Following are illustrative specifications for an embodiment having the components described above. The exterior-side glass 102 is ¼ inch thick and the interior-side glass 104 is ½ inch thick. The insulating space 106 is a 1 inch thick air space. The exterior-side glass 102 has an impact film 114, such as a three-tier Madico film, on the surface facing the air space. This same film is applied to both surfaces of the interior-side glass. As used herein, “interior-side” refers to the side of the apparatus facing the protected space. “Exterior-side” refers to the opposite side of the apparatus. The glass can be cut from any float glass, or similar substrate. The air space area has a dual seal, with the primary seal being a substance such as polyisobutylene (PIB). Upon assembly, a secondary sealant is applied, such as silicone structural adhesive. There is no edge deletion of film or removal of the film when bonded with the primary seal around the insulating space. The film extends to each exterior dimensional edge of each glass section to which it is applied. The entire thickness of this illustrative glass structure will be approximately 1 3/16 inches. The structure as described should meet or exceed Ballistic Standard UL 752 part 1.

Embodiments of the glass apparatus are unique because they may offer true insulated glass performance and can be assembled with most float glass type substrates, such as pyrolitic or vacuum deposition coated glass. Additionally, they can be used to provide UV protection. The insulated glass system may also offer a substantial weight reduction over a conventional bullet resistant assembly. The unit can be made with a strength comparable to any UL 752 bullet resistant product. The unit can also be less costly to manufacture than a laminated assembly but as easily or more easily manufactured.

Embodiments of the apparatus preferably have a thickness in the range of about 0.9 inch to about 2 3/16 inches (approximately 2.2 inches). Other illustrative ranges include about 0.9 inches to about 1.5 inches and about 1.0 inch to about 1.2 inches.

The apparatus preferably has an insulating space with a thickness in the range of about 0.5 inches to about 1.0 inches. The space may be filled with air, as was described in the embodiment above, or it may be filled with nitrogen, krypton, or other gases traditionally used for insulating purposes. The space may also be evacuated to provide thermal insulating and sound insulating properties.

In an illustrative embodiment, the glass thickness used in the assembly is a minimum of one pane about ¼ inch thick and an accompanying pane of a minimum of about ½ inch thick. Either of these panes of glass can be replaced with any glass thickness greater than indicated, but to maintain the lightness of the apparatus it is recommended to utilize glass of the minimum thickness that would still provide the necessary impact resistance or integrity. An illustrative glass thickness range includes about 0.21 inches to about 0.54 inches.

The unique use of applied film in the inventive bullet resistant glass provides advantages over traditional bullet resistance glass, for example, the ability to create a lighter weight structure. Embodiments of the invention provide a weight reduction as compared to other bullet resistant glass. The inventive, insulated bullet resistant glass can be made with only two pieces of glass. The inventive glass structure can be manufactured with an approximate weight of 9.4 lbs/ft², whereas traditional bullet resistant glass weighs approximately 14.0 lbs/ft². Traditional bullet resistant glass is over three inches thick, whereas the inventive glass can be made having a nominal thickness of 1 3/16 inches (30.1625 mm) and additionally performs as an insulated glass.

The inventive glass unit can include multiple glass substrates to provide a variety of performance specifications, such as those related to shading coefficient, solar heat reduction and UV deflection.

The air space can be created by for example, ½ inch aluminum anodized material, but there are numerous types of air space frame components that could be used, provided that they can withstand forces associated with the impact strength for which the unit is designed.

The unit can be configured as a seal insulated unit that does not need a framing device to hold it together. Frames and other retention devices are, however, within the scope of the invention. A frame of some type generally is used upon installation of any type of glass unit. The inventive glass unit can be mounted in a standard design and weight glazing system. Conventional bullet resistant structures cannot because of their respective weight. Standard glazing systems have a slot or pocket in which the glass edges sit, and a frame that fits around the periphery of the glass. The pocket is typically 1 5/16 inches. This can accommodate the inventive glass unit with stops and sealant as necessary.

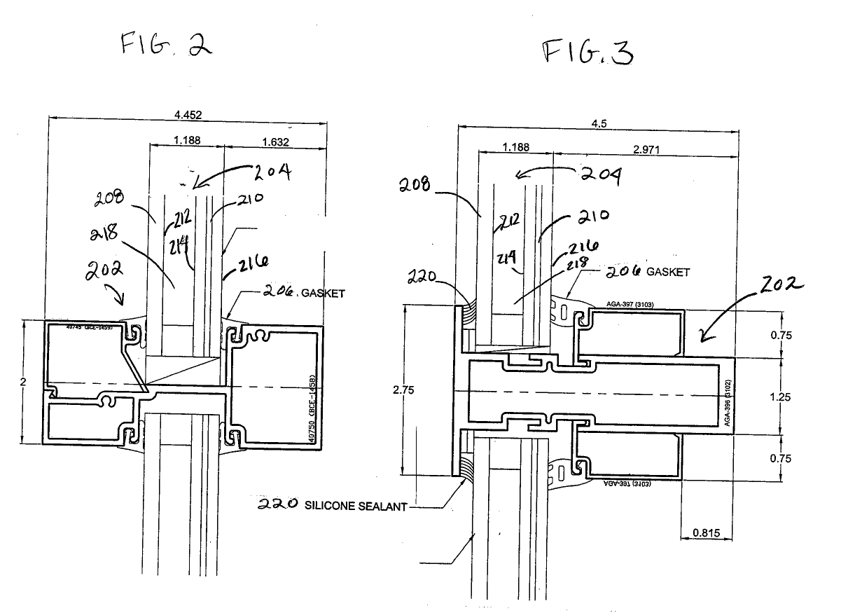

FIGS. 2 and 3 provide frames according to illustrative embodiments of the invention. These framed are preferably are constructed from aluminum, however, other materials such as wood, steel, vinyl fiberglass and various strong plastics can be used. The potential lightweight construction bolsters the benefits of the novel bullet resistant glass. Each figure shows frame portions 202 into which glass assemblies 204 are held. Gaskets 206 provide a seal between frames 202 and glass assemblies 204 on the protected space side of the apparatus, which will often be the interior of a building. A sealant 220, such as a silicone material may be applied between frames 202 and glass assemblies 204 on the opposite side of the glass assembly. In the embodiment depicted in FIGS. 2 and 3, the glass assembly includes two glass panes 208, 210 with three separate films 212, 214, 216 applied to the glass. An insulating space 218 is present between the glass panes. Frames can be of standard glazing design and type used in the glazing glass industry.

In an illustrative embodiment of the invention ballistics resistance is achieved by providing a 15 mil polyester (PET) based film onto at least the film-coated surfaces shown in FIG. 1. The film thickness is preferably in the range of about 5 mils to about 20 mils, and more preferably in the range of about 12 mils to about 16 mils. The film is preferably a multilayer polyester terephthalate construction where the piles of the film are adhered to one another using an acrylic based adhesive. The layer of film that is adhered to the glass surface facing the interior of the protected space is preferably coated with a UV-curable urethane based resin that provides scratch and abrasion resistance. Other scratch and abrasion resistant materials are within the spirit and scope of the invention.

Various film types may be used to impart desired properties to the bullet resistant glass structure. Variables include, but are not limited to tensile strength, tensile modulus, yield stress, yield strength, puncture strength, percent solar energy transmission/rejection, and shading coefficient.

While the invention has been described by illustrative embodiments, additional advantages and modifications will occur to those skilled in the art. Therefore, the invention in its broader aspects is not limited to specific details shown and described herein. Modifications, for example, to the film types and glass thicknesses may be made without departing from the spirit and scope of the invention. Accordingly, it is intended that the invention not be limited to the specific illustrative embodiments, but be interpreted within the full spirit and scope of the appended claims and their equivalents.

1. An insulated bullet resistant apparatus comprising:
an interior glass component having a glass sheet with a film applied to at least one side;
an exterior glass component having a glass sheet with a film applied to at least one side; and
an insulating space between the interior glass component and the exterior glass component;
wherein a face of the interior glass component having a film thereon faces a face of the exterior glass component having a film thereon.

2. The apparatus of claim 1 wherein the interior glass component has a film on both faces.

3. The apparatus of claim 1 wherein the insulating space is filled with air.

4. The apparatus of claim 1 wherein the insulating space is evacuated.

5. The apparatus of claim 1 wherein the thickness of the apparatus is in the range of about 0.9 inches to 2.2 inches.

6. The apparatus of claim 1 wherein the thickness of the apparatus is in the range of about 1.0 inches to 1.2 inches.

7. The apparatus of claim 1 wherein the insulating space has a thickness in the range of about 0.5 inches to about 1.0 inches.

8. The apparatus of claim 1 wherein the film material has a thickness in the range of about 5 mils to about 20 mils.

9. The apparatus of claim 8 wherein the film material has a thickness in the range of about 12 mils to about 16 mils.

10. The apparatus of claim 1 wherein the glass thicknesses are in the range of about 0.25 inches and about 0.50 inches.

11. The apparatus of claim 1 wherein at least one of the film layers is a polyester-based film.

12. The apparatus of claim 1 wherein the interior glass component has one glass sheet with a film applied to both faces of the glass sheet; and
the exterior glass component has one glass sheet with a film applied only to its surface facing the insulated space.

13. A method of forming an insulated, bullet resistant glass apparatus comprising:
applying a film to at least one side of an interior glass component;
applying a film to at least one side of an exterior glass component; and
creating an insulating space between the interior glass component and exterior glass component;
wherein a face of the interior glass component having a film thereon faces a face of the exterior glass component having a film thereon.
